(19) United States
(12) Patent Application Publication
(10) Pub. No.: US 2002/0083797 A1
(43) Pub. Date: Jul. 4, 2002

(54) Cork extraction tool

(76) Inventor: George J. Federighi SR., San Francisco, CA (US)

Correspondence Address: Harris Zimmerman, Esq., Suite 710, 1330 Broadway, Oakland, CA, 94612, US

(21) Appl. No.: 09/750,436

(22) Filed: Dec. 29, 2000

(51) Int. Cl. B67B 7/00

(52) U.S. Cl. 81/3.2

(57) ABSTRACT

A bottle cork extractor has a tubular needle carrier with an axially directed hollow needle of sufficient length to penetrate through the cork. Pressurized fluid is injected into the bottle through the needle and acts to eject the cork. A graspable sleeve encircles the needle carrier and has flexible tool positioning legs which extend downward along opposite sides of the bottle. Threads on the sleeve engage threads on the needle carrier. This enables easy penetration of the needle into the cork by turning the needle carrier relative to the sleeve and easy removal of the ejected cork from the needle by reversed turning of the carrier. Cutting blades on the tool positioning legs facilitate cutting of foil wrapping or the like at the top of bottle.

### TECHNICAL FIELD

This invention relates to devices for facilitating the withdrawal of corks or similar stoppers from bottles and more particularly to devices of this kind which inject pressurized gas into the bottle through the cork or the like.

### BACKGROUND OF THE INVENTION

Wine bottles and bottles for some other liquids are traditionally closed and sealed by a cork which is friction fitted into the neck of the bottle. Use of the conventional corkscrew for extraction of a cork is subject to problems well known to consumers of wine. Substantial physical effort and dexterity on the part of the user of the corkscrew is required. A corkscrew sometimes creates a disruption in the cork which allows the corkscrew to withdraw from the bottle without withdrawing the cork itself from the bottle.

Opening of corked bottles is more easily effected by using a cork extractor of the known type which injects a charge of pressurized fluid into the bottle through a needle which is penetrated through the cork. Expansion of the pressurized fluid ejects the cork from the bottle. Significant physical effort is still required as the user must force the needle through the cork and subsequently pull the cork off of the needle. The presence of an exposed sharp needle requires that the device be carefully handled and manipulated.

Bottle stoppers formed of natural cork are increasingly being replaced by synthetic corks formed of plastics or other materials which have physical properties similar to those of natural cork. Penetrating many of these synthetic materials with the needle requires more effort than penetration of natural cork. Corks formed of the synthetic materials may also exhibit more frictional resistance to removal of the cork from the needle. It would be advantageous if the forces required for these purposes were reduced.

The tops of corked wine bottles or the like are often capped with a wrapping of metal foil or similar material which is adhered to the necks of the bottles. The top of the foil wrapping must be ruptured or removed to enable withdrawal of the cork from the bottle. The pointed needle of a pressurized gas cork extractor is not a very effective tool for this purpose.

The present invention is directed to overcoming one or more of the problems discussed above.

### SUMMARY OF THE INVENTION

In one aspect the present invention provides a cork extractor tool for withdrawing a cork from a bottle, the tool has a tubular needle carrier and a hollow fluid injection needle which extends axially from the needle carrier. The needle forms a pressurized fluid passage and is of sufficient length to penetrate through a bottle cork. A pressurized fluid container is disposed at least partially within the needle carrier and a valve in the needle carrier is connected between the pressurized fluid container and the fluid passage of said needle. A graspable sleeve encircles the tubular needle carrier and has a base with an opening therein through which said needle extends. The needle carrier and needle are movable in an axial direction relative to the sleeve.

In another aspect of the invention the graspable sleeve and the tubular needle carrier of the cork extractor tool have engaged threads which cause axial movement of the needle carrier and needle relative to the sleeve in response to rotation of the needle carrier relative to the sleeve.

In another aspect of the invention, a pair of tool positioning legs extend from the graspable sleeve of the cork extractor tool in the direction of travel of said needle. The legs being are at opposite sides of the needle and are spaced apart by a distance sufficient to receive a bottle neck between the legs.

In still another aspect of the invention, a cork extractor tool for withdrawing a cork from a bottle includes a tubular needle carrier having a linear hollow needle extending axially from a bottom end of the carrier and having external threads. A pressurized fluid container is situated at least partially within the needle carrier and a manually operable valve in the carrier has an inlet communicated with the pressurized fluid container and an outlet communicated with the hollow needle. A graspable cylindrical sleeve disposed in coaxial relationship with the tubular needle carrier has internal threads which engage the external threads of the needle carrier enabling axial translation of the needle carrier and needle in response to rotation of the carrier relative to the sleeve. The sleeve has a base member with an opening therein through which the needle extends which opening has a diametrical dimension that is smaller than the diameter of a cork. The sleeve has a pair of tool positioning legs extending from the bottom end of the sleeve along opposite sides of the needle, the legs being spaced apart a distance sufficient to receive a bottle neck therebetween.

The invention facilitates opening of corked bottles with pressurized gas cork extractors by reducing the physical efforts and dexterity required for the purpose. Penetration of the needle of such an extractor into a cork is made easier and withdrawal of an impaled cork from the needle requires less physical force. The tool aligns the gas injection needle with the neck of the bottle during penetration of the cork. Accidental contact of the user's hands with the sharp needle point is inhibited. In a preferred form the invention also facilitates cutting away of the top of foil wrapping at the neck of a bottle.

The invention, together with further objects and advantages thereof may be further understood by reference to the following description of the preferred embodiment and by reference to the accompanying drawings.

### BRIEF DESCRIPTION OF THE DRAWINGS

FIG. 1 is a side view of a cork extractor tool in accordance with the preferred embodiment of the invention.

FIG. 2 is a broken out side view of the cork extractor tool of FIG. 1 taken at right angles to the plane of FIG. 1.

FIG. 3 is a cross section view of the cork extractor tool taken along line 3-3 of FIG. 2.

FIG. 4 is an end view of the cork extractor tool of the preceding figures taken along line 4-4 of FIG. 2.

FIG. 5 is an axial section view of the upper portion of the cork extractor tool showing the gas injection system thereof.

FIG. 6 is a partially broken out view depicting the cork extractor tool emplaced on the neck of a bottle which is to be opened.

FIG. 7 depicts use of the cork extractor tool for cutting away the top of a foil wrapping at the neck of a corked bottle.

FIG. 8 depicts ejection of a cork from the cork extractor tool following withdrawal of the cork from a bottle.

### DETAILED DESCRIPTION OF THE PREFERRED EMBODIMENT

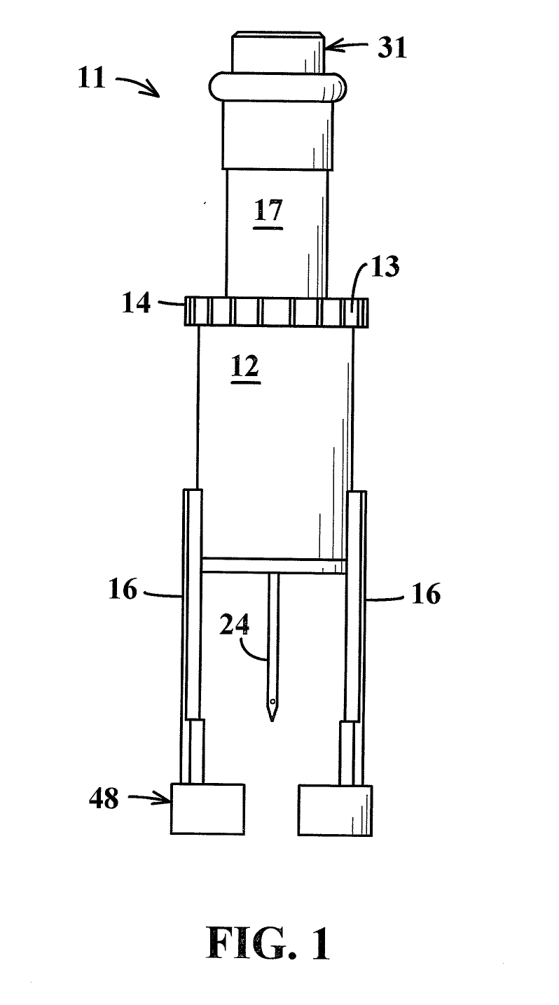

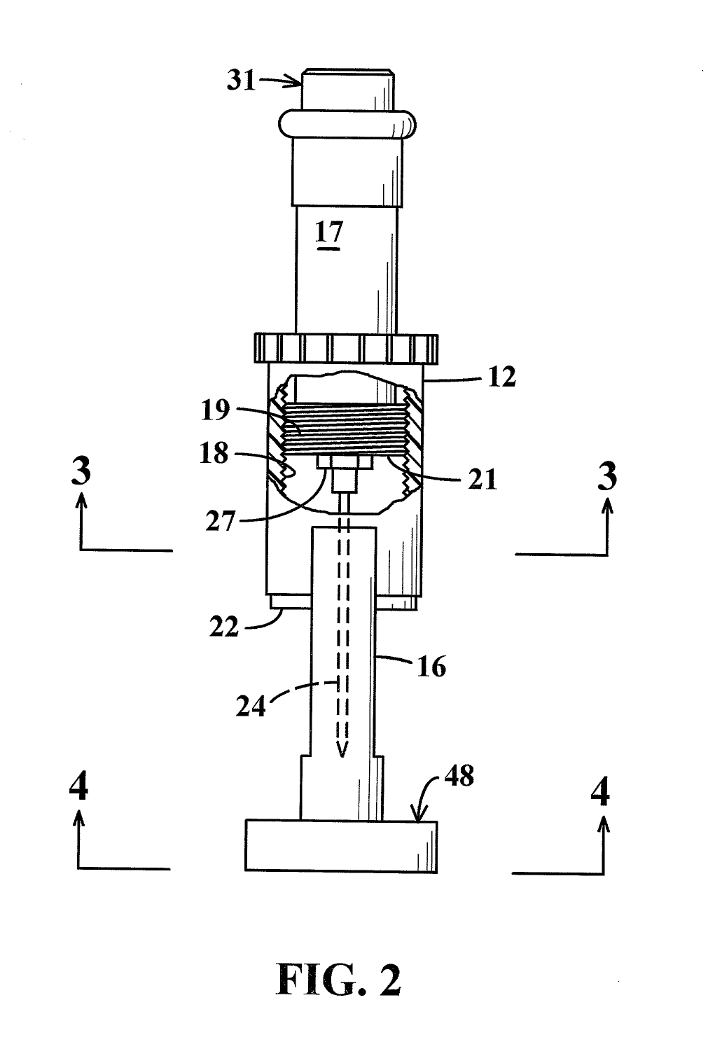

Referring initially to FIGS. 1 and 2 of the drawings, a cork extractor tool 11 in accordance with this embodiment of the invention has a cylindrical sleeve 12 which is grasped by one hand of the user of the device during the cork extraction process. A radially directed flange 13 at the top of sleeve 12 has angularly spaced apart protuberances 14 which aid in resisting turning of the sleeve during use. A pair of tool positioning legs 16 extend downward from the bottom end of sleeve 12, the legs being at opposite sides of the sleeve.

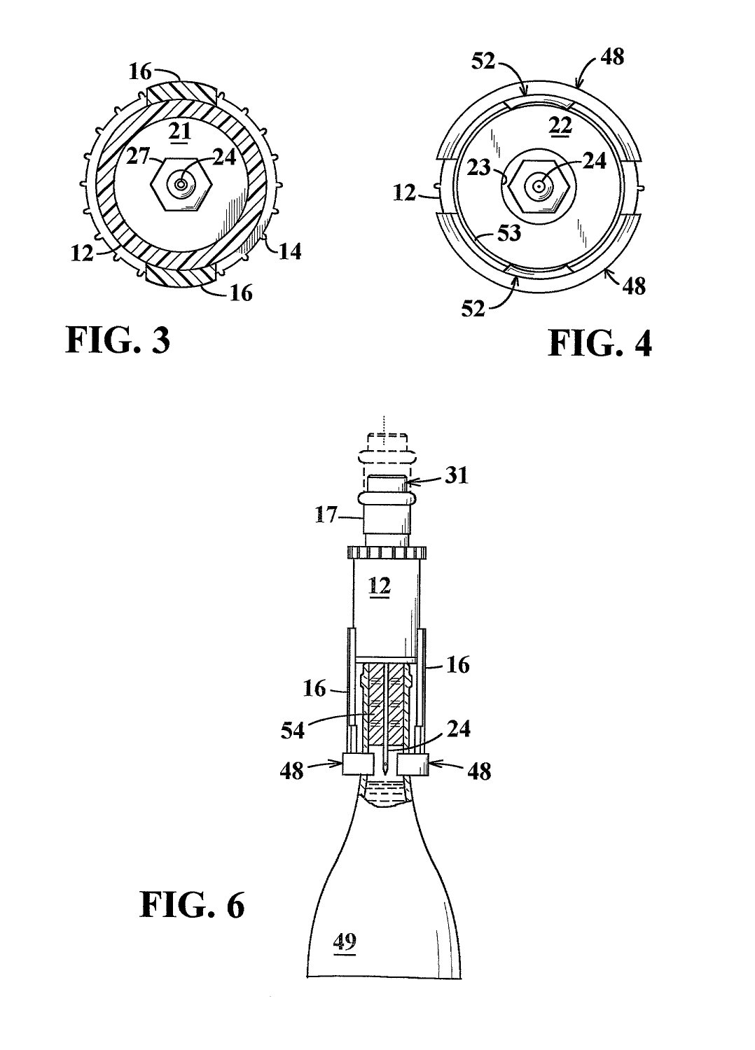

A tubular translatable needle carrier 17 extends into sleeve 12 in coaxial relationship with the sleeve and also extends out of the sleeve in the upward direction. Referring to FIGS. 2 and 3, sleeve 12 has internal threads 18 which are engaged by external threads 19 of an annular collar 21 that encircles the needle carrier 17 and which is secured to the needle carrier by adhesive or other means. Thus turning of the needle carrier 17 in one direction travels the carrier downward relative to sleeve 12 and reverse turning of the carrier travels the carrier upward. Referring to FIGS. 2 and 4, downward travel of the needle carrier 17 is limited by an annular base member 22 at the bottom of the sleeve 12. A centered opening 23 in base member 22 has a diameter which is smaller than the diameter of a bottle cork. This enables abutment of the base member 22 against the top of a bottle and against a peripheral portion of the cork of the bottle.

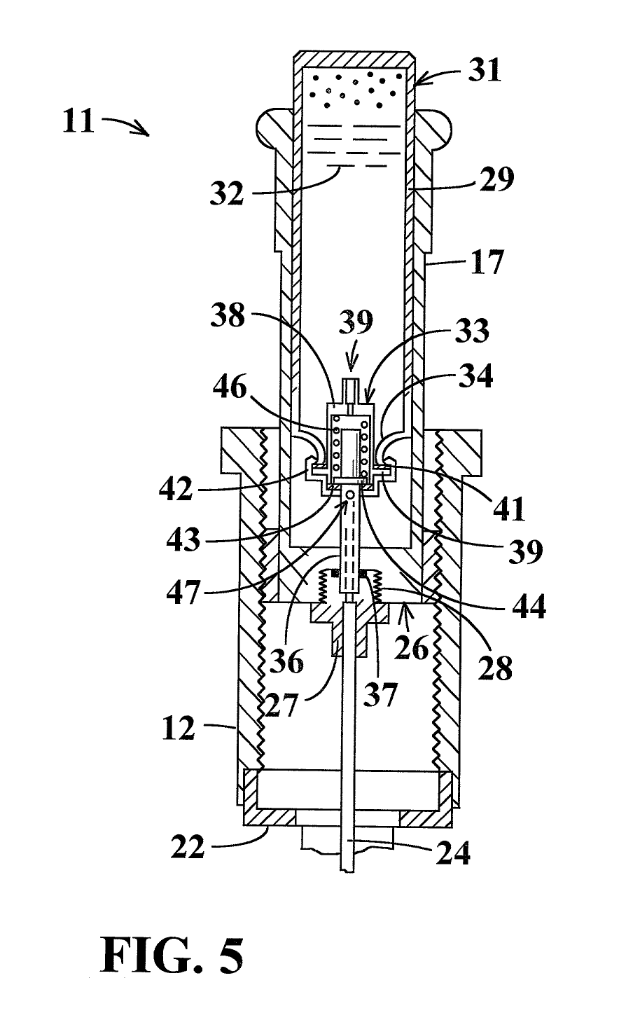

Referring jointly to FIGS. 2 and 5, a linear hollow pointed needle 24 extends downward from the base 26 of needle carrier 17 along the axis of the carrier and sleeve 12. Needle 24 is secured to a fitting 27 which is engaged to the base 26 of needle carrier 17 by threads 28. Needle 24 is of sufficient length to enable complete penetration of the needle through a cork along the axis of the cork.

Pressurized fluid is injected into the bottle through needle 24 and the resulting rise of pressure in the bottle acts to eject the cork. The fluid is initially contained in a tubular pressurized fluid container 29 which is inserted into the needle carrier 17 and which extends in coaxial relationship with the carrier. The upper end 31 of container 29 protrudes for a short distance from the top of needle carrier 17. The pressurized fluid 32 in container 29 in this particular example is a volatile liquid, such as liquefied Freon gas, having a boiling point below room temperatures. Alternately, the fluid may be a compressed gas of any of various types such as compressed carbon dioxide for example.

A valve 33 is disposed at an opening 34 at the bottom of container 29 and serves as a closure for the opening in addition to the valving function. User thumb pressure on the protruding upper end 31 of container 29 depresses the container 29 and this momentarily opens valve 33 to release a charge of pressurized fluid into needle 24 through a tubular valve member 36 that extends down to the previously described needle fitting 27 including through an O-ring seal 37 in the fitting.

Valve 33 is preferably of the metering type described in prior U.S. Pat. No. 4,791,834 which is herein incorporated by reference. A metering valve 33 releases a fixed volume of fluid from container 29 in response to each temporary downward movement of the container regardless of the duration of the downward movement. This avoids over-pressurization of a bottle which could cause an undesirably rapid ejection of the cork. A valve 33 of the preferred type has a cylindrical housing 38 that is in coaxial relationship with container 29 and which has a centered fluid inlet 39 at the top. Housing 38 has a flange 39 which abuts a gasket 41 that seats against the rim of container opening 34. An end cap 42 is crimped around the flange 39, gasket 41 and the rim of opening 34 to seal the opening and to secure the valve 33 to container 29.

Valve member 36 extends into housing 38 through end cap 42 and a resilient annular seal 43 at the base of the housing. The valve member 36 has a flange 44 which seats against seal 43 and a compression spring 46 in housing 38 extends between the flange 44 and the top of the housing. The spring 46 exerts an upward force on the housing 38. Upward motion of housing 38 and container 29 in response to the spring force is limited by abutment of end cap 42 and seal 43 against the flange 44. User thumb pressure against the upper end 31 of container 29 forces the container 29 including end cap 42 and seal 43 downward relative to flange 44. This movement exposes an inlet aperture 47 of tubular valve member 36 to the interior of housing 38 thereby causing a release of pressurized fluid into the bottle through the valve member 36 and needle 24. The discharge of fluid is limited to a fixed amount as the same movement causes the top of valve member 36 to seat against and close the inlet 39 of housing 38.

Referring of FIGS. 1, 2 and 4 in conjunction, the bottom end of each tool positioning leg 16 is a bottle clasping portion 48 of the leg which extends laterally at the lower end of the leg in each direction. The bottle clasping portions 48 has are curved with centers of curvature which are at needle 24 and jointly partially encircle the wine bottle 49 or the like when in use as shown in FIG. 6. The legs 16 are formed of a plastic or other material having sufficient resiliency to enable flexing of the legs towards bottle 49 to bring the clasping portions 48 into contact with the bottle. A user of the tool 11 may flex the legs 16 inward by squeezing the legs with the same hand that is grasping and supporting the tool.

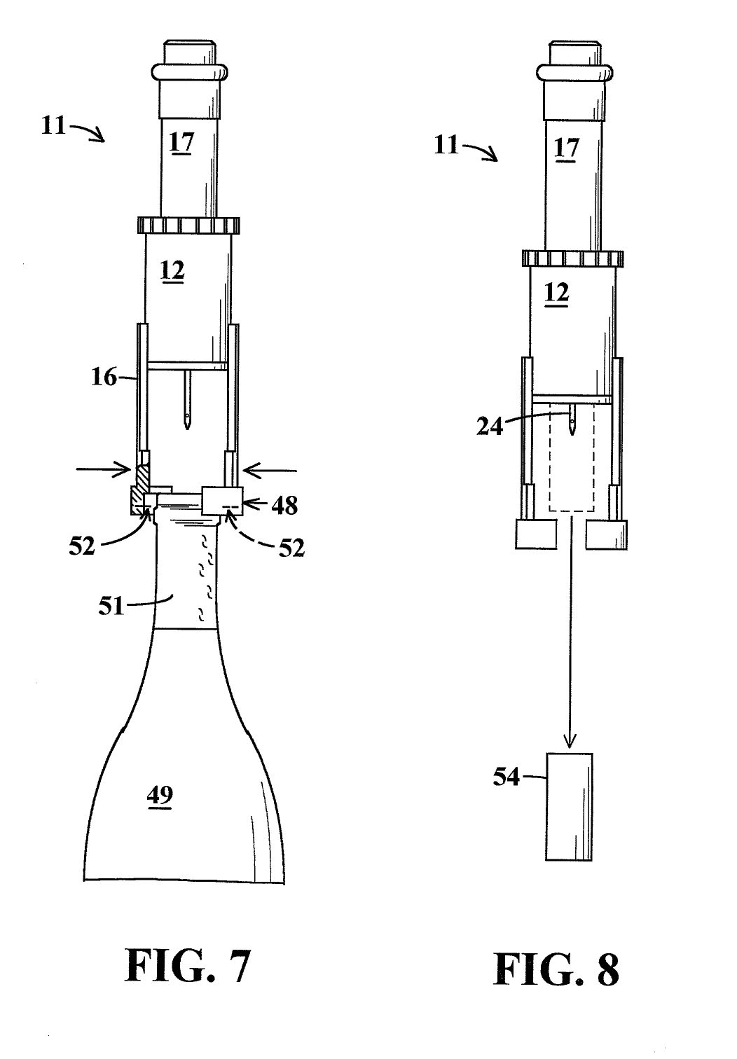

Referring to FIG. 7, many wine bottles 49 or the like have a wrapping 51 of metal foil or other material which encircles the neck of the bottle. The wrapping 51 typically extends across the top of the bottle 49 including the top of the cork and is adhered to the bottle. Tool 11 in the preferred form has cutting blades 52 which facilitate removal of the top portion of wrapping 51 prior to extraction of the cork. Referring jointly to FIGS. 4 and 7, cutting blades 52 are arcuate and extend a short distance inward toward the axis of the tool 11 from the bottle clasping portions 48 of legs 16. Inwardly directed steps 53 at the tops of the inner surfaces of the bottle clasping portions 48 may be rested against the rim of the top of the bottle 49 by flexing legs 16 inward in the previously described manner. Turning of the tool 11 relative to bottle 49 and/or turning of the bottle itself then makes a circular cut around the top of wrapping 51 which enables easy removal of that portion of the wrapping.

Referring again to FIG. 6, extraction of the cork 54 may be accomplished by turning needle carrier 15 relative to sleeve 12 to fully extend needle 24 from sleeve 12 in the downward direction. The tool 11 may then be forced towards bottle 49 to penetrate the needle 24 through the cork 54. Legs 16 including bottle clasping portions 48 establish a proper alignment of the tool 11 with bottle 49 during this operation and also shield the users hands from the sharp needle 24. Thumb pressure on the protruding top 31 of the pressurized fluid container then releases a charge of pressurized fluid into the bottle 49 in the previously described manner and causes ejection of the cork 54.

Penetration of needle 24 into cork 54 may also be accomplished in an alternate manner which requires less exertion of force on the part of the user. In the alternate mode of penetration, needle carrier 17 is turned relative to sleeve 12 to retract most of the needle 24 into sleeve 12. The tool 11 is then emplaced on the neck of the bottle 49 and needle 24 is forced into cork 54 for a short distance. The user may then hold sleeve 12 and legs 16 stationary with one hand while turning needle carrier 17 with the other hand to drive the needle further into the cork 54.

An important advantage of the tool 11 is that it facilitates removal of an ejected cork 54 from needle 24 which operation can otherwise require considerable force. Referring to FIG. 8, removal of the impaled cork 54 is easily accomplished by turning needle carrier 17 in the direction which retracts the needle 24 into sleeve 12. The cork 54 can then be pulled off of needle 24 with minimal effort or may simply fall off if the needle is fully retracted into the sleeve.

While the invention has been described with reference to a specific embodiment for purposes of example, many variations and modifications of the tool construction are possible and it is not intended to limit the invention except as defined in the following claims.

1. A cork extractor tool for withdrawing a cork from a bottle, said tool having a tubular needle carrier, a hollow fluid injection needle extending axially from said tubular needle carrier and forming a pressurized fluid passage and being of sufficient length to penetrate through a bottle cork, a pressurized fluid container disposed at least partially within said needle carrier and a valve disposed in said needle carrier and being connected between said pressurized fluid container and said pressurized fluid passage of said needle, wherein the improvement comprises:
a graspable sleeve encircling said tubular needle carrier and having a base with an opening therein through which said needle extends, said needle carrier and needle being movable in an axial direction relative to said sleeve.

2. The cork extractor tool of claim 1 wherein said graspable sleeve and said tubular needle carrier have engaged threads which cause axial movement of said needle carrier and needle relative to said sleeve in response to rotation of said needle carrier relative to said sleeve.

3. The cork extractor tool of claim 1 wherein a pair of tool positioning legs extend from said graspable sleeve in the direction of travel of said needle, said legs being at opposite sides of said needle and being spaced apart by a distance sufficient to receive a bottle neck between said legs.

4. The cork extractor tool of claim 3 wherein a lower end of each of said tool positioning legs has a bottle clasping portion thereat which bottle clasping portion extends laterally from the lower end of the leg and is curved to fit against a portion of the circumference of the bottle.

5. The cork extractor tool of claim 4 wherein said tool positioning legs are formed of a material having sufficient resiliency to enable flexing of said legs towards said bottle by a user of the tool.

6. The cork extractor tool of claim 5 wherein at least one of said tool positioning legs has a cutting blade secured thereto which blade is directed towards said needle.

7. In a cork extractor tool for withdrawing a cork from a bottle, the combination comprising:
a tubular needle carrier having a linear hollow needle extending axially from a bottom end of the carrier and having external threads,
a pressurized fluid container situated at least partially within said needle carrier,
a manually operable valve in said needle carrier, said valve having an inlet communicated with said pressurized fluid container and having an outlet communicated with said hollow needle, and
a graspable cylindrical sleeve disposed in coaxial relationship with said tubular needle carrier and having internal threads which engage said external threads of said needle carrier enabling axial translation of said needle carrier and needle in response to rotation of said needle carrier relative to said sleeve, said sleeve having a base member with an opening therein through which said needle extends which opening has a diametrical dimension that is smaller than the diameter of a cork, said sleeve having a pair of tool positioning legs extending from a bottom end of the sleeve along opposite sides of said needle, said legs being spaced apart a distance sufficient to receive a bottle neck therebetween.
